(19) United States
(12) Patent Application Publication
(10) Pub. No.: US 2026/0336022 A1
(43) Pub. Date: Oct. 29, 2026

(54) DEVICE AND METHOD FOR MACHINING A WORKPIECE BY MEANS OF AT LEAST TWO LASER BEAMS

(71) Applicant: TRUMPF Laser SE, Schramberg (DE)

(72) Inventors: Torsten Mans, Aachen (DE); Christian Weddeling, Niefern-Öschelbronn (DE)

(21) Appl. No.: 19/703,136

(22) Filed: Jun. 10, 2026

Related U.S. Application Data
(63) Continuation of application No. PCT/EP2024/084838, filed on Dec. 5, 2024.

(30) Foreign Application Priority Data
Dec. 14, 2023 (DE) 10 2023 135 197.4

(51) Int. Cl. B23K 26/064; B23K 26/082; B23K 26/36

(52) U.S. Cl. CPC B23K 26/0652; B23K 26/082; B23K 26/36

(57) ABSTRACT

A device for machining a workpiece by using at least two laser beams includes a first laser unit for generating a first laser beam having a first wavelength, a second laser unit for generating a second laser beam having a second wavelength different from the first wavelength, a superposition unit for generating a superposed laser beam by superposing the first laser beam and the second laser beam, an amplifier unit for amplifying the superposed laser beam, a separating unit for separating the superposed laser beam into the first beam and the second laser beam, and a focusing unit for focusing the first laser beam onto a first position on the workpiece, and for focusing the second laser beam onto a second position on the workpiece, the second position being different from the first position.

### CROSS REFERENCE TO RELATED APPLICATIONS

This application is a continuation of International Application No. PCT/EP2024/084838 (WO 2025/125073 A1), filed on Dec. 5, 2024, and claims benefit to German Patent Application No. DE 10 2023 135 197.4, filed on Dec. 14, 2023. The aforementioned applications are hereby incorporated by reference herein.

### FIELD

Embodiments of the present invention relate to a device for machining a workpiece by means of at least two laser beams and a method for machining a workpiece by means of at least two laser beams.

### BACKGROUND

For a variety of laser material machining applications, short laser pulses with high laser pulse repetition rates are required in order to be able to achieve, for example, high areal rates in machining. Besides the temporal precision of pulse emission, the achievable speed of spatial deflection is often a technical limitation. Furthermore, achieving the laser intensity required for machining is usually technically difficult.

### SUMMARY

Embodiments of the present invention provide a device for machining a workpiece by using at least two laser beams. The device includes a first laser unit for generating a first laser beam having a first wavelength, a second laser unit for generating a second laser beam having a second wavelength different from the first wavelength, a superposition unit for generating a superposed laser beam by superposing the first laser beam and the second laser beam, an amplifier unit for amplifying the superposed laser beam, a separating unit for separating the superposed laser beam into the first beam and the second laser beam, and a focusing unit for focusing the first laser beam onto a first position on the workpiece, and for focusing the second laser beam onto a second position on the workpiece, the second position being different from the first position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a device for machining a workpiece by means of at least two laser beams according to some embodiments.

### DETAILED DESCRIPTION

Embodiments of the present invention provide a device and a method for machining a workpiece by means of at least two laser beams, thereby eliminating the above disadvantages.

The device comprises a first laser unit for generating a first laser beam having a first wavelength and a second laser unit for generating a second laser beam having a second wavelength different from the first wavelength.

The device comprises a superposition unit for generating a superposed laser beam by superposing, in particular coherently, the first and the second laser beams. The superposition unit can comprise a lens for coupling the first and second laser beams (e.g., into a fiber) or be designed as such a lens. The superposition unit can be designed as a single-mode fiber combiner.

The device comprises an amplifier unit for amplifying the superposed laser beam and a separating unit for separating the superposed laser beam into the first and second laser beams. The superposed laser beam can have a spectral bandwidth that lies within the spectral bandwidth of the amplifier unit. The separating unit can be arranged after the amplifier unit. The separating unit can be configured to introduce an angular dispersion of the first and second laser beams.

The device also comprises a focusing unit for focusing the first laser beam on a first position on the workpiece and for focusing the second laser beam on a second position, different from the first position, on the workpiece. In particular, the first position is spaced apart from the second position on the workpiece. In the present case, the distance between the first position and the second position refers to the distance between a first center point of the first laser beam focused on the workpiece and a center point of the second laser beam focused on the workpiece along a surface of the workpiece. It is conceivable that the laser spots generated on the workpiece by the two laser beams could overlap.

The focusing unit can have a focal length of 600 mm (millimeters). The first and/or the second wavelength can each lie in a spectral band from −70 nm to +70 nm around 1030 nm.

This allows for the amplification of the first and second laser beams using simple means. Optimal machining of the workpiece can thus be achieved.

According to a further development of the device, the amplifier unit can comprise a rod amplifier, a fiber, a slab amplifier, and/or a disk amplifier. The individual amplifiers mentioned above can be arranged one after the other in the order mentioned above, if present. Of course, a different order of the amplifiers mentioned above is also conceivable, if present. It is also conceivable that the amplifier unit may comprise another amplifier.

The amplifier unit can comprise an active medium (e.g., Yb:glass, Yb:LuAG (ytterbium-doped lutetium aluminum garnet), Yb:YAG (ytterbium-doped yttrium aluminum garnet), or Yb-doped fused silica). The active medium can comprise laser-active ions (e.g., Yb3+). The active medium can be doped with Yb. The active medium can be located inside an amplifier, e.g., a fiber.

The device can have a Mamyshev regenerator for pulse shortening. The Mamyshev regenerator can be positioned before the amplifier unit.

In the present case, terms such as “before” an element or “after” an element refer to a propagation direction of the first laser beam, the second laser beam, and/or the superposed laser beam.

This allows the amplifier unit to be implemented using simple means and the superposed laser beam to be amplified.

According to a further development of the device, the separating unit can comprise at least one dispersive element. The dispersive element can be designed as an optical grating and/or as a prism.

This allows the separating unit to be implemented using simple means and the superposed laser beam to be separated again into the first laser beam and the second laser beam.

According to a further development of the device, the separating unit can comprise at least two dispersive elements. The at least two dispersive elements can be configured in such a way that a distance between the first and the second laser beam can be adjusted by varying a distance and/or an orientation of the at least two dispersive elements with respect to one another.

The two dispersive elements can be rotatably mounted. This allows, for example, the angle between the two dispersive elements to be adjusted around an axis perpendicular to the propagation or dispersion plane. The distance between the first position of the first laser beam and the second position of the second laser beam on the workpiece can be adjusted, for example, by rotating the first and/or the second dispersive element.

This allows the distance between the first and second laser beams to be adjusted or varied using simple means.

According to a further development of the device, the separating unit can be configured such that the first and second laser beams have a distance in an angular space after separation which is in a range of 1 μrad (microradian) to 1 mrad (milliradian).

This allows the first and second laser beams to be optimally further processed, in particular focused on the workpiece.

According to a further development of the device, the first and the second laser unit can each comprise at least one pulsed laser. The pulsed laser can have a pulse duration in a range from 100 fs (femtosecond) to 1 μs (microsecond), in particular in a range of at least 40 ps (picosecond) to a maximum of 1 ns (nanosecond). The pulsed laser can have a pulse repetition rate of 200 MHz (megahertz) to 800 MHz. Alternatively, the first and second laser units can each comprise at least one CW (continuous wave) laser. The laser source can be a laser diode, in particular a gain-switched diode, preferably a DFB (distributed feedback) diode.

The device can comprise at least one third laser unit for generating a third laser beam having a third wavelength. The third wavelength can be different from the first and/or the second wavelength. The third laser unit can comprise at least one pulsed laser (in particular with pulses in a range of 1 ns (nanosecond) to 1 ms (microsecond)) or at least one CW laser (or a long-pulsed laser diode). The third wavelength may lie at the edge of an amplifier bandwidth of the amplifier unit. The third laser beam can be used to compensate for or adjust the inversion in the amplifier unit.

The device can comprise a fourth laser unit for generating a fourth laser beam having a fourth wavelength. The first, second and fourth laser beams can each be generated by means of a pulsed laser. The first, second and fourth wavelengths can have a distance of a central wavelength of 1 nm (nanometer). The first wavelength can be 1029 nm, the second wavelength can be 1030 nm and the fourth wavelength can be 1031 nm. The spectral width of the first, second, and fourth laser units (or their respective pulsed lasers) can be less than 0.1 nm. In this case (analogous to two laser beams), three laser beams are superposed to form one superposed laser beam, amplified, and then separated again into three individual laser beams. Of course, the number of laser beams that are superposed, amplified and separated again can also be higher, i.e., four or more. The number of laser beams that can be superposed, amplified, and separated again may be limited, for example, by the bandwidth of the amplifier unit or the active medium.

This allows the individual laser beams to be generated as flexibly as possible, thus enabling the machining of the workpiece to be implemented as flexibly as possible.

According to a further development of the device, the ratio of the spectral width of the first wavelength and the second wavelength to the spectral distance between the first wavelength and the second wavelength can be 1:5, in particular 1:10, preferably 1:20.

This allows the first and second laser beams to be superposed or separated as optimally as possible. Furthermore, the ellipticity in the focus can be kept low by dispersion of the separating unit or the dispersive element.

According to a further development of the device, the first laser unit can comprise at least two pulsed lasers. In this case, the at least two, and in particular all, pulsed lasers can each be configured to generate a partial beam with the same wavelength. In this case, at least two, and in particular all, partial beams can be pulse-shifted. In particular, the shift can be more than one pulse duration. At least two, and in particular all, partial beams can form the first laser beam.

Alternatively or additionally, the second laser unit can comprise at least two pulsed lasers in each case. In this case, the at least two, and in particular all, pulsed lasers can each be configured to generate a partial beam with the same wavelength. In this case, at least two, and in particular all, partial beams can be pulse-shifted. At least two, and in particular all, partial beams can form the second laser beam.

This allows the first or second laser beam to be implemented with a very high pulse repetition rate using simple means.

According to a further development of the device, the first and/or the second laser unit can comprise a temperature-control unit for varying the temperature of the first and/or the second laser unit. The first and/or the second laser unit can each be configured in such a way that the first wavelength and/or the second wavelength (or their respective center wavelengths) can be shifted or varied. The shift or variation can be in a range of 0.01 nm/K to 0.5 nm/K, in particular 0.06 nm/K (nanometers per kelvin). The temperature of the temperature-control unit can be controlled, for example, by means of a temperature regulator.

This allows the temperature of the first and/or second laser unit to be varied or adjusted using simple means. In particular, the wavelength of the first or second laser unit can be changed or adjusted via the temperature. This can be achieved in particular in diode lasers, in which the junction temperature of the pn junction determines the central wavelength of the amplification, or in DFB (distributed feedback) diodes, in which the spacings of the internal grid structure are changed. By adjusting the wavelengths, the dispersion in the separating unit can be adjusted, and thus the distance between the first laser beam and the second laser beam can be adjusted.

According to a further development of the device, the device can comprise a scanner optical assembly for moving the first and/or the second laser beam on the workpiece. The scanner optical assembly can be arranged before the focusing unit.

This allows the movement of the first or second laser beam on the workpiece to be implemented using simple means.

According to a further development of the device, the scanner optical assembly can comprise a galvo scanner and/or a polygon scanner.

This allows the scanner optical assembly to be implemented using simple means.

According to a further development of the device, the device can comprise a converter unit for converting the first and/or the second wavelength. In this case, the wavelength can be halved or divided by three, or the frequency corresponding to the wavelength can be doubled or tripled. The converter unit can comprise a nonlinear crystal. The converter unit can be configured to filter out the third laser beam, in particular by means of the nonlinear crystal. The converter unit can be arranged after or before the separating unit. The converter unit can be arranged before the scanner optical assembly.

This allows the desired wavelength to be achieved using simple means.

According to a further development of the device, the device can comprise at least one control unit for controlling the first laser unit, the second laser unit, the third laser unit, the separating unit, the temperature-control unit and/or the scanner optical assembly.

This allows for the control of the device or its individual elements using simple means.

According to a further development of the device, the focusing unit can be configured such that the distance between the first position and the second position is in a range of 0.5 μm (micrometers) to 5 mm, in particular 1 μm to 100 μm.

This allows the machining of the workpiece to be implemented in the most optimal way possible.

The above problem is solved by a method for machining a workpiece by means of at least two laser beams having the features of the additional independent claim. The method comprises the steps:
generating a first laser beam having a first wavelength by means of a first laser unit;
generating a second laser beam having a second wavelength, different from the first wavelength, by means of second laser unit;
generating a superposed laser beam by superposing, in particular coherently, the first and the second laser beam;
amplifying the superposed laser beam;
separating the superposed laser beam into the first and the second laser beam;
focusing the first laser beam on a first position on the workpiece and focusing the second laser beam on a second position, different from the first position, on the workpiece.

This allows for the amplification of the first and second laser beams using simple means. Optimal machining of the workpiece can thus be achieved.

According to a further development of the method, the method can comprise the step: changing the distance, in particular the spatial distance, between the first and second laser beams.

This allows the machining of the workpiece to be adjusted as desired and optimally.

According to a further development of the method, the method can comprise the step: generating the first and/or the second laser beam from at least two pulsed partial beams, wherein at least two, in particular all, partial beams have the same wavelength and are pulse-shifted relative to each other.

This allows the first or second laser beam to be implemented with a very high pulse repetition rate using simple means.

According to a further development of the method, the method can comprise the step: varying the temperature of the first and/or second laser unit.

This allows the first wavelength or the second wavelength (in particular in temperature-sensitive laser units) to be adjusted as desired using simple means.

According to a further development of the method, the method can comprise the step: moving the first and/or second laser beam on the workpiece.

This allows the workpiece to be machined as desired using simple means.

According to a further development of the method, the method can comprise the step: converting the first and/or the second wavelength.

This allows the wavelength desired for machining the workpiece to be adjusted using simple means.

According to a further development of the method, a device as described above can be used to carry out the method.

With regard to the advantages that can be achieved, reference is made to the relevant statements relating to the device. The measures described in connection with the device and/or those explained below can be used to further develop the method.

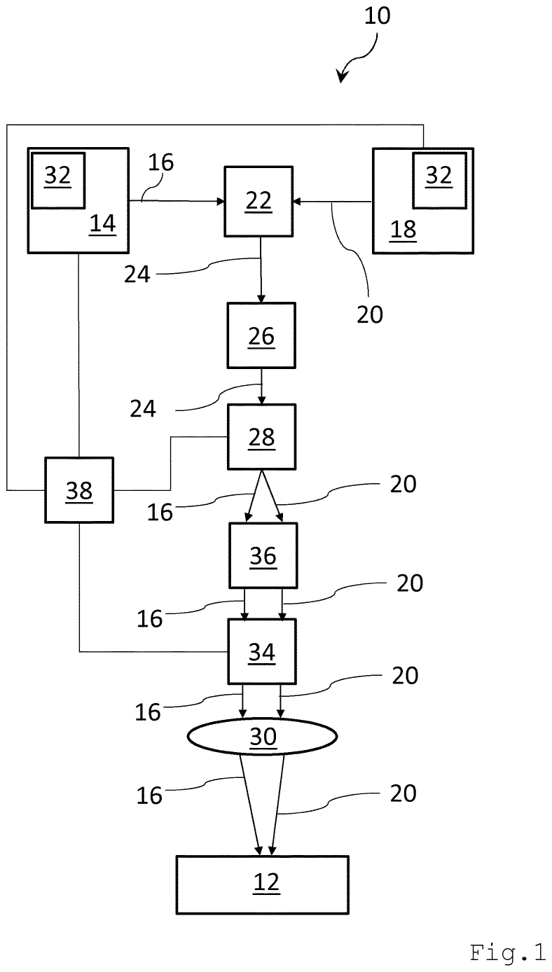

In FIG. 1, the device as a whole bears the reference sign 10. The device 10 is configured to machine a workpiece 12 by means of at least two laser beams 16, 20.

The device 10 comprises a first laser unit 14 for generating a first laser beam 16 having a first wavelength and a second laser unit 18 for generating a second laser beam 20 having a second wavelength different from the first wavelength.

The device 10 comprises a superposition unit 22 for generating a superposed laser beam 24 by superposing the first and the second laser beams 16, 20. The device 10 also comprises a separating unit 28 for separating the superposed laser beam 24 into the first and the second laser beams 16, 20.

The device 10 comprises a focusing unit 30 for focusing the first laser beam 16 on a first position on the workpiece 12 and for focusing the second laser beam 20 on a second position, different from the first position, on the workpiece 12.

The focusing unit 30 can be configured such that the distance between the first position and the second position is in a range of 0.5 μm to 5 mm, in particular 1 μm to 100 μm.

The amplifier unit 26 can comprise a rod amplifier, a fiber, a slab amplifier, and/or a disk amplifier.

The separating unit 28 can comprise at least one dispersive element. This can be designed, for example, as an optical grating and/or as a prism.

The separating unit 28 can comprise at least two dispersive elements. The at least two dispersive elements can be configured such that a distance between the first and the second laser beam 16, 20 can be adjusted by varying a distance and/or an orientation of the at least two dispersive elements with respect to one another.

The separating unit 28 can be configured such that the first and second laser beams 16, 20 have a distance in an angular space after separation which is in a range of 1 μrad to 1 mrad.

The first and second laser units 14, 18 can each comprise at least one pulsed laser and/or at least one CW laser. The device 10 can comprise at least one third laser unit for generating a third laser beam having a third wavelength (not shown). The third laser unit can comprise at least one pulsed laser or at least one CW laser.

The ratio of the spectral width of the first wavelength and the second wavelength to the spectral distance between the first wavelength and the second wavelength can be 1:5, in particular 1:10, preferably 1:20.

The first laser unit 14 can comprise at least two pulsed lasers. In this case, the at least two, and in particular all, pulsed lasers can each be configured to generate a partial beam with the same wavelength. In this case, at least two, and in particular all, partial beams can be pulse-shifted. At least two, in particular all, partial beams can form the first laser beam 16.

The second laser unit 18 can comprise at least two pulsed lasers. In this case, the at least two, and in particular all, pulsed lasers can each be configured to generate a partial beam with the same wavelength. In this case, at least two, and in particular all, partial beams can be pulse-shifted. At least two, in particular all, partial beams can form the second laser beam 20.

In the present case, the first and the second laser unit 14, 18 each comprise a temperature-control unit 32 for varying a temperature of the first or the second laser unit 14, 18.

In the present case, the device 10 comprises a scanner optical assembly 34 for moving the first and/or the second laser beam 16, 20 on the workpiece 12. The scanner optical assembly 34 can comprise a galvo scanner and/or a polygon scanner. In the present case, the scanner optical assembly 34 is arranged before the focusing unit 30.

In the present case, the device 10 comprises a converter unit 36 for converting the first and the second wavelength. The wavelength can be halved or divided by three, for example. In the present case, the converter unit 36 is arranged before the scanner optical assembly 34.

In the present case, the device 10 comprises a control unit 38. In the present case, the control unit 38 is configured to control the first laser unit 14, the second laser unit 18, the separating unit 28, the temperature-control unit 32 of the first laser unit 14, the temperature-control unit 32 of the second laser unit 18 and the scanner optical assembly 34.

In the following, a method for machining a workpiece 12 by means of at least two laser beams 16, 20 is described with reference to the device 10 shown in FIG. 1.

The method comprises the steps:
generating a first laser beam 16 having a first wavelength by means of a first laser unit 14;
generating a second laser beam 20 having a second wavelength different from the first wavelength by means of a second laser unit 18;
generating a superposed laser beam 24 by superposing the first and the second laser beams 16, 20;
amplifying the superposed laser beam 24;
separating the superposed laser beam 24 into the first and second laser beams 16, 20;
focusing the first laser beam 16 on a first position on the workpiece 12 and focusing the second laser beam 20 on a second position, different from the first position, on the workpiece 12.

The method may comprise at least one of the following steps:
changing the distance between the first and second laser beams 16, 20.
generating the first and/or the second laser beam 16, 20 from at least two pulsed partial beams, wherein at least two, in particular all, partial beams have the same wavelength and are pulse-shifted relative to each other.
varying the temperature of the first and/or the second laser unit 14, 18.
moving the first and/or the second laser beam 16, 20 on the workpiece 12.
converting the first and/or the second wavelength.

To carry out the method, a device 10 according to the above descriptions, in particular the device 10 shown in FIG. 1, can be used.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for machining a workpiece by using at least two laser beams, the device comprising:
a first laser unit for generating a first laser beam having a first wavelength,
a second laser unit for generating a second laser beam having a second wavelength different from the first wavelength,
a superposition unit for generating a superposed laser beam by superposing the first laser beam and the second laser beam,
an amplifier unit for amplifying the superposed laser beam,
a separating unit for separating the superposed laser beam into the first beam and the second laser beam, and
a focusing unit for focusing the first laser beam onto a first position on the workpiece, and for focusing the second laser beam onto a second position on the workpiece, the second position being different from the first position.

2. The device according to claim 1, wherein the amplifier unit comprises a rod amplifier, a fiber, a slab amplifier, and/or a disk amplifier.

3. The device according to claim 1, wherein the separating unit comprises at least one dispersive element.

4. The device according to claim 3, wherein the separating unit comprises at least two dispersive elements configured such that a distance between the first laser beam and the second laser beam is adjustable by varying a distance and/or an orientation of the at least two dispersive elements with respect to one another.

5. The device according to claim 1, wherein the separating unit is configured such that the first laser beam and the second laser beam have an angular distance in an angular space therebetween after separation, the angular distance being in a range of 1 μrad to 1 mrad.

6. The device according to claim 1, wherein each of the first laser unit and the second laser unit comprises at least one pulsed laser or at least one continuous-wave (CW) laser.

7. The device according to claim 1, wherein a ratio of a spectral width of the first wavelength and/or the second wavelength to a spectral distance between the first wavelength and the second wavelength is 1:5.

8. The device according to claim 1, wherein each of the first laser unit and the second laser unit comprises at least two pulsed lasers, wherein each of the at least two pulsed lasers is configured to generate a respective partial beam having a same wavelength, wherein the partial beams generated by the at least two pulsed lasers are pulse-shifted relative to each other.

9. The device according to claim 1, wherein the first laser unit and/or the second laser unit comprises a temperature-control unit for varying a temperature of the first laser unit and/or the second laser unit.

10. The device according to claim 1, further comprising a scanner optical assembly for moving the first laser beam and/or the second laser beam on the workpiece.

11. The device according to claim 10, wherein the scanner optical assembly comprises a galvo scanner and/or a polygon scanner.

12. The device according to claim 1, further comprising a converter unit for converting the first wavelength and/or the second wavelength.

13. The device according to claim 1, further comprising at least one control unit for controlling the first laser unit, the second laser unit, and the separating unit.

14. The device according to claim 1, wherein the focusing unit is configured such that a distance between the first position and the second position is in a range of from 0.5 μm to 5 mm.

15. A method for machining a workpiece by using at least two laser beams, the method comprising:
generating a first laser beam having a first wavelength by using a first laser unit;
generating a second laser beam having a second wavelength different from the first wavelength by using a second laser unit;
generating a superposed laser beam by superposing the first laser beam and the second laser beam;
amplifying the superposed laser beam;
separating the superposed laser beam into the first laser beam and the second laser beam; and
focusing the first laser beam on a first position on the workpiece and focusing the second laser beam on a second position on the workpiece, the second position being different from the first position.

16. The method according to claim 15, further comprising:
changing a distance between the first laser beam and the second laser beam.

17. The method according to claim 15, further comprising:
generating each of the first laser beam and the second laser beam from at least two pulsed partial beams, wherein the at least two partial beams have a same wavelength and are pulse-shifted relative to each other.

18. The method according to claim 15, further comprising:
varying a temperature of the first laser unit and/or the second laser unit.

19. The method according to claim 15, further comprising:
moving the first laser beam and/or the second laser beam on the workpiece.

20. The method according to claim 15, further comprising:
converting the first wavelength and/or the second wavelength.
